(19) United States
(12) Patent Application Publication
(10) Pub. No.: US 2011/0018404 A1
(43) Pub. Date: Jan. 27, 2011

(54) SPINDLE MOTOR

(76) Inventor: Kwangseok An, Seoul (KR)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 12/842,755

(22) Filed: Jul. 23, 2010

(30) Foreign Application Priority Data
Jul. 24, 2009 (KR) 10-2009-0067683

(51) Int. Cl. H02K 5/16

(52) U.S. Cl. 310/425

(57) ABSTRACT

A spindle motor is disclosed. The spindle motor includes a bearing housing inserted therein by a bearing, a stator fixed at a periphery of the bearing housing, a rotation shaft rotatably supported by the bearing and formed thereunder with a hitching unit, a rotor fixed at the rotation shaft, and a support member arranged at a floor surface of the bearing housing to rotatably support the hitching unit and formed with a hitching protruder at which the hitching unit is hitched, whereby the number of constituent components is reduced to improve the assemblage.

### CROSS-REFERENCE TO RELATED APPLICATION

This application claims the benefit under 35 U.S.C. §119 of Korean Application No. 10-2009-0067683, filed Jul. 24, 2009, which is hereby incorporated by reference in its entirety.

### BACKGROUND

The present disclosure relates to a spindle motor configured to improve assemblage.

Generally, a spindle motor, which is a radial core type brushless direct-current (BLDC) motor, is widely used as rotating means of a recording medium that requires a high speed rotation such as a hard disk drive or an optical disk drive.

In order to rotate a disk at a high speed, the spindle motor may include a rotation shaft, a bearing rotatably supporting the rotation shaft, a bearing housing accommodating the bearing, a stator fixed at the housing, a rotor fixed at the rotation shaft for rotating in association with the stator, and a base plate coupled to an external surface of the bearing housing.

Friction may be generated between the rotation shaft and the bearing housing if the rotation shaft forthrightly contacts a floor surface of the bearing housing, because a lower distal end of the rotation shaft is supported by a floor surface of the bearing housing. The friction generated between the rotation shaft and the bearing housing causes damage to parts, generation of noise and decreased life of the spindle motor.

In order to solve the aforementioned drawbacks, the floor surface of the bearing housing is installed with a thrust plate. Furthermore, in order to prevent the rotation shaft from horizontally and vertically fluctuating at a high speed, the bearing housing is installed with a stopper washer. The stopper washer is hitched by a lower distal end of the rotation shaft to prevent the rotation shaft from moving upwards.

However, there is a disadvantage in the assemblage of the conventional spindle motor in that the thrust plate is inserted into the bearing housing, the stopper washer is inserted and the bearing is press-fitted, thereby complicating the assemblage.

Another disadvantage is that components may be omitted or missed due to slip-up by an operator in the assembly process because the thrust plate and the stopper washer are relatively small-sized.

### BRIEF SUMMARY

The present disclosure is to provide a spindle motor configured to integrally form a thrust plate and a stopper washer, thereby reducing the number of components and improving assemblage of a product.

Exemplary embodiments may, however, be implemented in many different forms and should not be construed as being limited to the embodiments set forth herein; Other features and advantages of the disclosed embodiments will be or will become apparent to one of ordinary skill in the art upon examination of the following figures and detailed description.

This Summary is provided to introduce, in a simplified form, a selection of concepts that are further described below in the Detailed Description. This Summary is not intended to identify key features or essential features of the claimed subject matter, nor is it intended to be used to limit the scope of the claimed subject matter.

According to one aspect of the present disclosure, the object described above may be achieved by a spindle motor which comprises: a bearing housing inserted therein by a bearing; a stator fixed at a periphery of the bearing housing; a rotation shaft rotatably supported by the bearing and formed thereunder with a hitching unit; a rotor fixed at the rotation shaft; and a support member arranged at a floor surface of the bearing housing to rotatably support the hitching unit and formed with a hitching protruder at which the hitching unit is hitched.

In some exemplary embodiments of the present disclosure, the support member may include a support unit supported by a lower surface of the hitching unit, a washer unit hitched by the hitching unit to prevent the rotation shaft from axially moving, and a connection unit connecting the support unit and the washer unit.

In some exemplary embodiments of the present disclosure, the support unit may take the form of a disk, and the connection unit may be perpendicularly and extensively formed from a margin of the support unit.

In some exemplary embodiments of the present disclosure, the washer unit may be accommodated at a lower surface thereof on a seat unit formed at a lower side of the bearing housing, and be supported at an upper surface thereof by a lower end of the bearing.

In some exemplary embodiments of the present disclosure, the bearing housing may include a bearing accommodator for accommodating the bearing, and a support member accommodator formed with an internal diameter smaller than that of the bearing accommodator for accommodating the support member.

In some exemplary embodiments of the present disclosure, the rotation shaft may include a main shaft unit, a neck unit formed at a lower section of the main shaft unit and formed with an outer diameter smaller than that of the main shaft unit, and a hitching unit at which the neck unit is hitched.

In some exemplary embodiments of the present disclosure, the hitching protruder may be circumferentially formed at an inner surface of the washer unit and discrete at a predetermined interval from the washer unit.

In some exemplary embodiments of the present disclosure, the hitching protruder may be formed opposite to an inner surface of the washer unit, and a distance from the washer unit may be shorter than an outer diameter of the hitching unit of the rotation shaft but greater than an outer diameter of the neck unit.

In some exemplary embodiments of the present disclosure, the support member may be formed therein with an accommodation groove by the support unit and the connection unit, and the hitching unit of the rotation shaft may be hitched by the accommodation groove.

### BRIEF DESCRIPTION OF DRAWINGS

FIG. 1 is a cross-sectional view of a spindle motor according to an exemplary embodiment of the present disclosure.

FIG. 2 is an enlarged view along line A-A of FIG. 1.

FIG. 3 is a plan view illustrating a support member of a spindle motor according to an exemplary embodiment of the present invention.

FIG. 4 is a partially exploded perspective view of a spindle motor according to an exemplary embodiment of the present invention.

### DETAILED DESCRIPTION

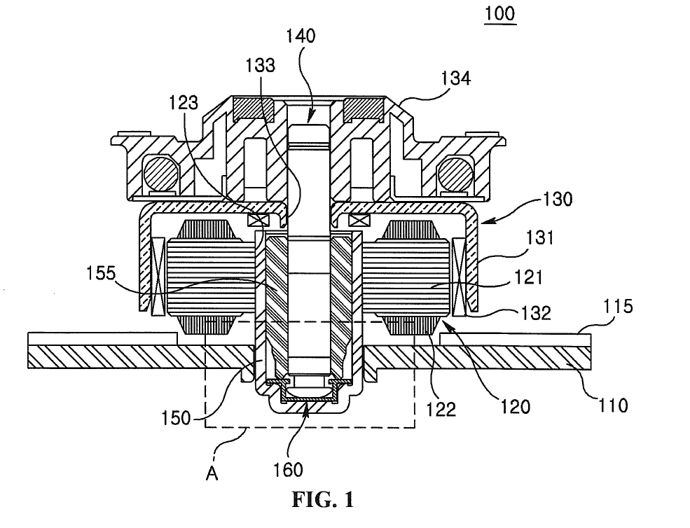

FIG. 1 is a cross-sectional view of a spindle motor according to an exemplary embodiment of the present disclosure.

Referring to FIG. 1, a spindle motor 100 according to an exemplary embodiment of the present disclosure may include a base plate 110, a stator 120, a rotor 130, a rotation shaft 140 and a bearing housing 150.

The base plate 110 is coupled at an upper surface thereof to a circuit substrate 115, and the bearing housing 150 is fixed at a middle section of the base plate 110. The stator 120 is fixed at the bearing housing 150, and the rotor 130 is fixed at the rotation shaft 140. The rotation shaft 140 is rotatably supported by bearings 155 arranged inside the bearing housing 150.

The stator 120 may include a core 121 fixed at a periphery of the bearing housing 150, and a coil 122 wound on the core 121. The rotor 130 may include a rotor yoke 131 coupled to the rotation shaft 140, and a magnet 132 fixed at an inner circumferential surface of the rotor yoke 131 and arranged opposite to the stator 120 at a predetermined interval. The rotor yoke 131 is centrally provided with a coupling hole 133 into which the rotation shaft 140 is press-fitted. The rotor yoke 131 is mounted at an upper surface thereof with a clamp device 134.

The clamp device 134 supports a disk in such a manner that a center of the disk matches a center of the rotation shaft 140, and functions to support the disk lest the rotating disk should be lifted.

Accordingly, in a case a current is applied to the coil 122, the rotor 130 is rotated along with the rotation shaft 140 by electromagnetic fields formed between the stator 120 and the magnet 132.

The core 121 is centrally formed with a through hole 123, and the through hole 123 is inserted by the bearing housing 150 to allow the core 121 to be fixed at the bearing housing 150.

The bearing housing 150 is provided in a cylindrical shape with an open upper side and a closed lower side, and is mounted at an inner circumferential surface thereof with a bearing 155, is mounted at a periphery with the core 121 of the stator 120, and is fixed thereunder by the base plate 110.

The bearing 155 is shaped of a cylinder, and is rotatably supported by the rotation shaft 150 therein. A floor surface of the bearing housing 155 is mounted at a floor surface thereof with a support member 160 that rotatably supports a lower surface of the rotation shaft 150 and that restricts the rotation shaft 150 from axially moving.

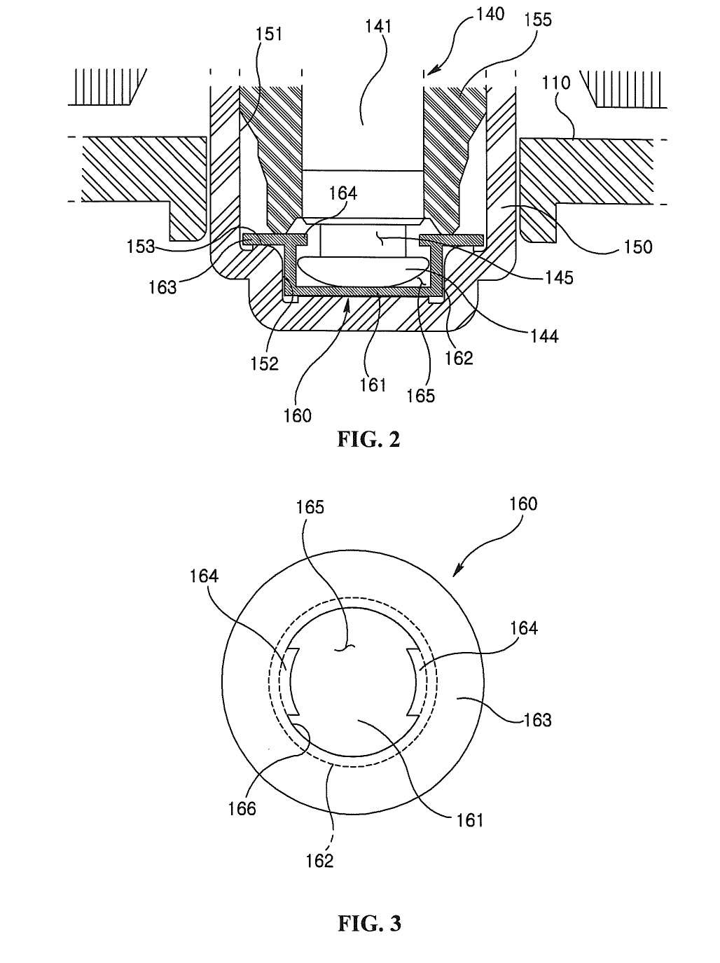

FIG. 2 is an enlarged view along line A-A of FIG. 1.

Referring to FIG. 2, the bearing housing 155 may include a bearing accommodator 151 into which the bearing 155 is inserted, and a support member accommodator 152 on which the support member 160 is installed.

A width of the support member accommodator 152 is smaller than that of the bearing accommodator 151. The bearing accommodator 151 is provided thereunder with a seat unit 153 on which the support member 160 is accommodated.

The rotation shaft 140 coupled to the rotor yoke 131 and the clamp device 134 includes a main shaft unit 141 rotatably supported in an inner circumferential surface of the bearing 155, a neck unit 145 extended from a lower distal end of the main shaft unit 141, and a hitching unit 144 formed at a distal end of the neck unit 145 and hitched by the support member 160.

The neck unit 145 has a smaller outer diameter than that of the hitching unit 144 and the main shaft unit 141, and the hitching unit 144 is formed of a round shape at a lower surface thereof to be rotatably supported by the support member 160.

Referring to FIGS. 2 and 3, the support member 160 may include a support unit 161 arranged at the support member accommodator 152 of the bearing housing 150 so as to rotatably support the hitching unit 144 of the rotation shaft 140, a washer unit 153 arranged at the seat unit 153 of the bearing housing 159 for hitching the hitching unit 144 of the rotation shaft 140, and a connection unit 162 connecting the support unit 161 and the washer unit 153.

The disk-shaped support unit 161 functions to play as a thrust bearing and rotatably supports the rotation shaft 140. Furthermore, the ring-shaped washer unit 153 is contacted at an upper surface thereof by the bearing 155, arranged at a lower surface thereof on the seat unit 153 of the bearing housing 150, and is protrusively and inwardly formed at an inner surface thereof with at least two hitching protruders 164.

At this time, a pair of hitching protruders 164, each facing the other, may be provided, for example, and an inner diameter of the hitching protruders 164 is smaller than an outer diameter of the hitching unit 144 but larger than an outer diameter of the neck unit 145, such that the hitching unit 144 may be hitched by the hitching protruders 164.

The connection unit 162 may be of a cylindrical shape perpendicularly extended from a margin of the support unit 161. Of course, the support unit 161 and the connection unit 162 may be formed of various other shapes. An accommodation groove 165 may be formed by the connection unit 162 and the support unit 161, and the accommodation groove 165 may be accommodated therein by the hitching unit 144 of the rotation shaft 140.

The hitching unit 144 of the rotation shaft 140 may freely rotate in a state of being contacted by an upper surface of the support unit 161. The washer unit 163 is mounted on the seat unit 153 of the bearing housing 150 and contacts a lower distal end of the bearing 155 for being pressed toward the seat unit 153. The washer 163 is centrally formed with an insertion hole 166. The insertion hole 166 may have a larger internal diameter than an outer diameter of the hitching unit 144 to be inserted by the hitching unit 144 of the rotation shaft 140 through the insertion hole 166.

The pair of hitching protruders 164 is integrally provided with the washer unit 163 so as to protrude toward the axial center at a circumference of the insertion hole 166. The internal diameter of the insertion hole 166 is made to be smaller than the outer diameter of the hitching unit 144 by the pair of the hitching protruders 164. As a result, in a case the rotation shaft 140 moves upwards, the hitching unit 144 is hitched by the pair of the hitching protruders 164, whereby the hitching unit 144 is restricted in movement to the axial direction. The pair of hitching protruders 164 is arranged at a circumference of the rotation shaft 140 at a predetermined space. The number of the hitching protruders 164 is not limited to a pair but may be variably changed.

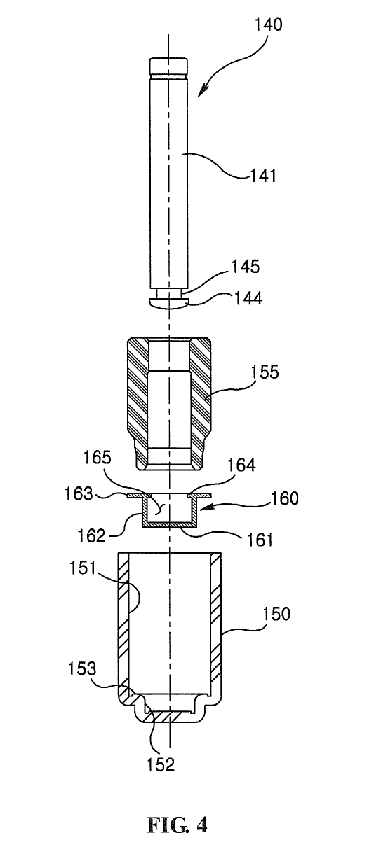

FIG. 4 is a partially exploded perspective view of a spindle motor according to an exemplary embodiment of the present invention.

Referring to FIG. 4, the support member 160 is inserted into the bearing housing 150 prior to the bearing 155 in a case the spindle motor 100 is assembled, and the bearing 155 is inserted into the bearing accommodator 151 of the bearing housing 150 to compress the washer unit 163 of the support member 160 downward. As a result, the support member 160 maintains a state of being inserted into the support member accommodator 152 unless the bearing is detached from the bearing housing 150.

As apparent from the foregoing, the spindle motor 100 according to the exemplary embodiment of the present disclosure is such that the support member 160 inserted into the support member accommodator 152 of the bearing housing 150 functions to prevent the rotation shaft 140 from being detached, to reduce the generation of noise and to increase the life of the spindle motor. The spindle motor 100 according to the exemplary embodiment of the present disclosure allows the conventional thrust plate and stopper washer having the aforementioned functions to be deleted, thereby reducing the number of constituent components, easing the assemblage and reducing the risk of constituent components being omitted due to operator's slip-up or mistake.

Any reference in this specification to “one embodiment,” “an embodiment,” “exemplary embodiment,” etc., means that a particular feature, structure, or characteristic described in connection with the embodiment is included in at least one embodiment of the disclosure. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with others of the embodiments. As used herein, the singular forms “a,” “an” and “the” are intended to include the plural forms as well, unless the context clearly indicates otherwise.

Although embodiments have been described with reference to a number of illustrative embodiments thereof, it should be understood that numerous other modifications and embodiments can be devised by those skilled in the art that will fall within the spirit and scope of the principles of this invention. More particularly, various variations and modifications are possible in the component parts and/or arrangements of the subject combination arrangement within the scope of the disclosure, the drawing and the appended claims. In addition to variations and modifications in the component parts and/or arrangements, alternative uses will also be apparent to those skilled in the art.

What is claimed is:

1. A spindle motor comprising:
a bearing housing inserted therein by a bearing;
a stator fixed at a periphery of the bearing housing;
a rotation shaft rotatably supported by the bearing and formed thereunder with a hitching unit;
a rotor fixed at the rotation shaft; and
a support member arranged at a floor surface of the bearing housing to rotatably support the hitching unit and formed with a hitching protruder at which the hitching unit is hitched.

2. The spindle motor of claim 1, wherein the support member includes a support unit supported by a lower surface of the hitching unit, a washer unit hitched by the hitching unit to prevent the rotation shaft from axially moving, and a connection unit connecting the support unit and the washer unit.

3. The spindle motor of claim 2, wherein the support unit takes the form of a disk, and the connection unit is perpendicularly and extensively formed from a margin of the support unit.

4. The spindle motor of claim 2, wherein the washer unit is accommodated at a lower surface thereof on a seat unit formed at a lower side of the bearing housing, and is supported at an upper surface thereof by a lower end of the bearing.

5. The spindle motor of claim 2, wherein the bearing housing includes a bearing accommodator for accommodating the bearing, and a support member accommodator formed with an internal diameter smaller than that of the bearing accommodator for accommodating the support member.

6. The spindle motor of claim 2, wherein the rotation shaft includes a main shaft unit, a neck unit formed at a lower section of the main shaft unit and formed with an outer diameter smaller than that of the main shaft unit, and a hitching unit at which the neck unit is hitched.

7. The spindle motor of claim 2, wherein the hitching protruder is circumferentially formed at an inner surface of the washer unit and discrete at a predetermined interval from the washer unit.

8. The spindle motor of claim 2, wherein the hitching protruder is formed opposite to an inner surface of the washer unit, and a distance from the washer unit to an outer surface of the hitching protruder is smaller than an outer diameter of the hitching unit of the rotation shaft but greater than an outer diameter of the neck unit.

9. The spindle motor of claim 2, wherein the support member is formed therein with an accommodation groove by the support unit and the connection unit, and the hitching unit of the rotation shaft is hitched by the accommodation groove.
